(19) United States
(12) Patent Application Publication
(10) Pub. No.: US 2025/0105242 A1
(43) Pub. Date: Mar. 27, 2025

(54) LITHIUM METAL LAYER TRANSFER ONTO ANODE CURRENT COLLECTOR

(71) Applicant: GM GLOBAL TECHNOLOGY OPERATIONS LLC, Detroit, MI (US)

(72) Inventors: Anil K. SACHDEV, Rochester Hills, MI (US); Xiaosong HUANG, Novi, MI (US); Mark W. VERBRUGGE, Sonoma, CA (US); John P. HEALY, Rochester Hills, MI (US)

(21) Appl. No.: 18/474,704

(22) Filed: Sep. 26, 2023

(51) Int. Cl. H01M 4/04; H01M 4/02; H01M 4/36; H01M 4/38; H01M 4/74; H01M 10/0565; H01M 50/46

(52) U.S. Cl. CPC H01M 4/0409; H01M 4/0407; H01M 4/366; H01M 4/382; H01M 4/742; H01M 4/745; H01M 10/0565; H01M 50/46; H01M 2004/027; H01M 2300/0082

(57) ABSTRACT

A method for manufacturing an anode electrode includes providing a first substrate, a second substrate, and an anode current collector. The method includes forming a first lithium metal layer on the first substrate and a second lithium metal layer on the second substrate. The method includes pressing the first lithium metal layer and the second lithium metal layer into the anode current collector to form an anode electrode.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to anode electrodes for battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

### SUMMARY

A method for manufacturing an anode electrode includes providing a first substrate, a second substrate, and an anode current collector; forming a first lithium metal layer on the first substrate and a second lithium metal layer on the second substrate; and pressing the first lithium metal layer and the second lithium metal layer into the anode current collector to form an anode electrode.

In other features, the method includes removing the first substrate and the second substrate after the pressing. The first substrate comprises a separator layer. The first substrate comprises a polymer film.

In other features, the method includes forming the first lithium metal layer on the first substrate includes at least one of electroplating, vapor deposition, powder coating, and spraying the first lithium metal layer on the first substrate. The first substrate comprises a solid electrolyte layer. The solid electrolyte layer is selected from a group consisting of a polymer electrolyte, an oxide-based electrolyte, and a sulfide-based electrolyte.

In other features, the solid electrolyte layer is selected from a group consisting of a solvent-free polymer electrolyte layer, a gel polymer electrolyte layer, a composite polymer electrolyte layer, a polyethylene oxide (PEO) layer, a polyacrylonitrile (PAN) layer, a polycarbonate layer, and a polysiloxane layer. The method includes arranging a protective layer on the first substrate between the first lithium metal layer and the first substrate. The protective layer comprises ceramic. The protective layer is selected from a group consisting of alumina, zirconia, zeolites, lithiated zeolites, and combinations thereof.

In other features, the method includes adding a conductive layer to at least one surface of the first substrate prior to forming the first lithium metal layer on the first substrate. The anode current collector comprises one of a mesh current collector, an expanded metal current collector, and a perforated current collector. The anode current collector is made of a material selected from a group consisting of copper, stainless steel, brass, bronze, zinc, aluminum, and alloys thereof.

A method for manufacturing an anode electrode includes providing a first substrate, a second substrate, and an anode current collector including voids. The anode current collector comprises one of a mesh current collector, an expanded metal current collector, and a perforated current collector. The anode current collector is made of a material selected from a group consisting of copper, stainless steel, brass, bronze, zinc, aluminum, and/or alloys thereof. The method includes forming a first lithium metal layer on the first substrate and a second lithium metal layer on the second substrate. Forming the first lithium metal layer on the first substrate includes at least one of electroplating, vapor deposition, powder coating, and spraying the first lithium metal layer on the first substrate. The method includes pressing the first lithium metal layer and the second lithium metal layer into the voids of the anode current collector to form an anode electrode.

In other features, the method includes removing the first substrate and the second substrate after the pressing. The first substrate comprises a solid electrolyte layer. The first substrate comprises a polymer layer. The method includes arranging a protective layer on the first substrate between the first lithium metal layer and the first substrate, wherein the protective layer comprises ceramic. The method includes forming a conductive layer on the first substrate prior to forming the first lithium metal layer on the first substrate.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell including cathode electrodes, anode electrodes, and separators arranged in a battery cell enclosure according to the present disclosure;

FIGS. 2A to 2D are side cross-sectional views of examples of anode electrodes according to the present disclosure;

FIG. 3 is a plan view illustrating masking of a substrate prior to forming a lithium metal layer on the substrate according to the present disclosure; and

FIG. 4 is a flowchart of an example of a method for manufacturing an anode electrode according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

Battery cells such as lithium-ion battery cells include cathode electrodes, anode electrodes, and separators. The anode electrodes include an anode active material layer such as a lithium metal layer arranged on an anode current collector. The lithium metal layer is difficult to deposit at a uniform thickness. Further, the lithium metal layer is currently limited to widths of 100 mm.

An anode electrode according to the present disclosure includes a lithium metal layer and an anode current collector. The lithium metal layer is formed on a substrate (e.g., a separator layer, a polymer film, a solid electrolyte layer, or a discarded substrate). The lithium metal layer and the substrate are pressed (e.g., between rollers or a press) onto one or both sides of the anode current collector. The lithium metal layer is pressed into voids of the anode current collector. In some examples, the substrate is removed from the lithium metal layer after pressing and discarded. Alternately, the substrate may correspond to a separator layer or solid electrolyte layer for a lithium-ion battery cell.

In some examples, the anode current collector is a 3 dimensional (3D) current collector such as a wire mesh, expanded metal, and/or perforated foil (including voids between the metal). The lithium metal layer is pushed into the voids of the anode current collector. The substrate may be used to prevent the lithium metal layer from directly contacting the rollers or the press, which prevents sticking to the rollers or the press. Defects in the lithium metal layer after pressing will become homogenized with the high strain that occurs while pressing the lithium metal layer into the voids of the anode current collector. Therefore, the lithium metal layer does not need to be deposited perfectly onto the substrate.

In some examples, the substrate is masked prior to adding the lithium metal layer onto the substrate to limit locations where the lithium metal layer is formed on the substrate. The masks help to define the shape of the anode electrode that will be cut from the multi-layer structure.

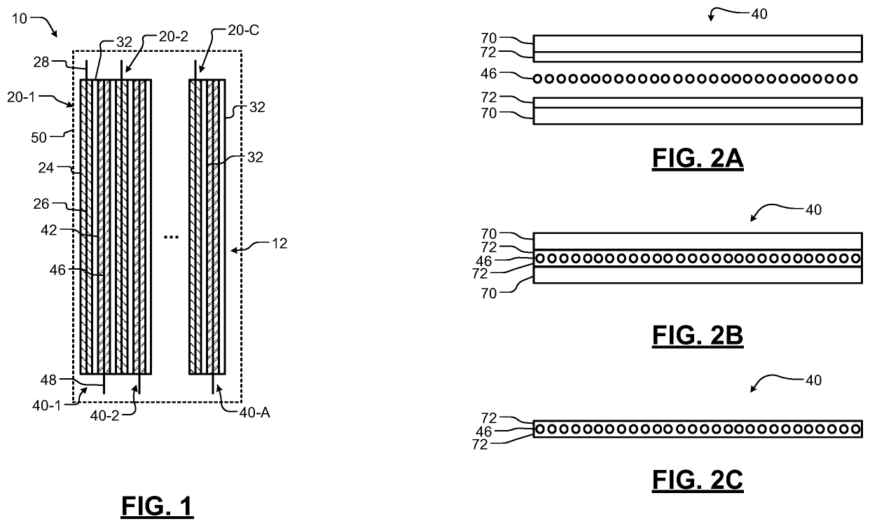

Referring now to FIG. 1, a battery cell 10 includes C cathode electrodes 20, A anode electrodes 40, and S separators 32 arranged in a predetermined sequence in a battery cell stack 12 located in an enclosure 50, where C, S and A are integers greater than zero. The C cathode electrodes 20-1, 20-2, . . . , and 20-C include cathode active material layers 24 arranged on one or both sides of cathode current collectors 26. The A anode electrodes 40-1, 40-2, . . . , and 40-A include anode active material layers 42 (e.g., including the lithium metal layer) arranged on one or both sides of the anode current collectors 46.

In some examples, the cathode active material layers 24 are free-standing electrodes that are arranged adjacent to (or attached to) the cathode current collectors 26, respectively. In some examples, the cathode active material layers 24 comprise coatings including one or more active materials, one or more conductive fillers/additives, and/or one or more binder materials that are applied to the current collectors.

In some examples, the cathode current collectors 26 comprise metal foil, metal mesh, and/or expanded metal. In some examples, the anode current collectors 46 comprise metal mesh, expanded metal, and/or perforated metal. In some examples, the cathode current collectors 26 and/or the anode current collectors 46 are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or opposite sides of the battery cell stack 12. The external tabs 28 and 48 are connected to terminals of the battery cells.

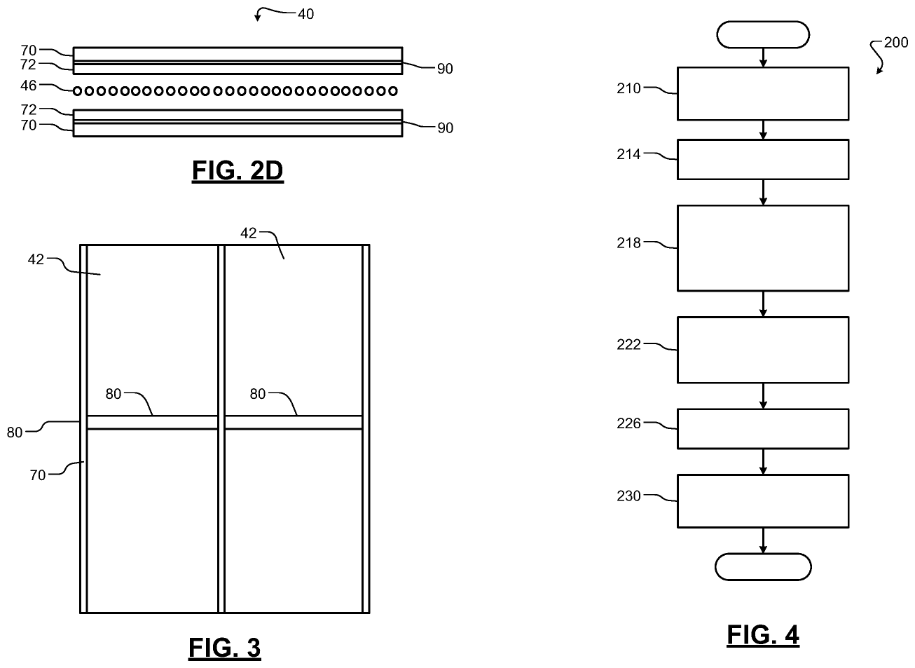

Referring now to FIGS. 2A to 20, a substrate 70 and the anode active material layer (e.g., a lithium metal layer 72) are shown prior to pressing the lithium metal layer 72 onto one or both sides of the anode current collector 46 (FIG. 2A) using a press and/or a roller. In some examples, the lithium metal layer 72 is electroplated, vapor deposited, powder coated, and/or sprayed onto the substrate 70 prior to pressing.

In some examples, the substrate(s) 70, the lithium metal layer(s) 72 and the anode current collector 46 are fed through one or more sets of rollers with a predefined gap therebetween to press the layers. After pressing, the lithium metal layer 72 is forced into voids in the anode current collector 46 to mechanically connect the layers.

In some examples, the substrate 70 may comprise a separator layer that that is not removed prior to assembly into a battery cell (FIG. 2B). Forming the lithium metal layer on the separator layer reduces waste (e.g., relative to another substrate 70 that is used temporarily to support the lithium metal layer 72 and then discarded). Examples of the substrate 70 (e.g., the separator layer) include a polymer film. Examples of the polymer film include porous membranes (e.g., polyolefin, poly(vinylidene fluoride) (PVDF), polyethylene terephthalate, etc.).

In other examples, the substrate 70 comprises a ceramic layer. In some examples, the ceramic layer is selected from a group consisting of alumina, zirconia, zeolites, lithiated zeolites, or other suitable ceramic materials.

In other examples, the substrate 70 includes a solid electrolyte layer. When the substrate 70 includes the solid electrolyte layer, the solid electrolyte layer is not removed prior to assembly into the battery cells. Forming the lithium metal layer on the solid electrolyte layer reduces waste (e.g., vs another substrate 70 that is used temporarily to support the lithium metal layer 72 and then discarded). In some examples, the solid electrolyte layer is selected from a group consisting of a polymer electrolyte, an oxide-based electrolyte, and/or a sulfide-based electrolyte.

In some examples, the polymer electrolyte is selected from a group consisting of a solvent-free polymer electrolyte layer, a gel polymer electrolyte layer, a composite polymer electrolyte layer, a polyethylene oxide (PEO) layer, a polyacrylonitrile (PAN) layer, a polycarbonate layer, and a polysiloxane layer.

Examples of oxide-based electrolytes include garnet type (e.g., Li₇La₃Zr₂O₁₂), perovskite type (e.g., Li₃ₓLa_{2/3-x}TiO₃), NASICON type (e.g., Li_{1.4}Al_{0.4}Ti_{1.6}(PO₄)₃, Li₁₊ₓAlxGe₂₋ₓ(PO₄)₃), LISICON type (e.g., Li₂₊₂ₓZn₁₋ₓ GeO₄), or other suitable oxide-based solid electrolyte.

Examples of sulfide-based electrolytes include xLi₂S-(100-x)P₂S₅, Li₆PS₅X (where X=chlorine (CI), bromine (Br), or iodine (I)), L₁₀GeP₂S₁₂ (LGPS), or other suitable sulfide solid electrolyte material. In some examples, the oxide-based or sulfide-based solid electrolyte is prepared using a powder that is pressed at elevated temperatures to form a thin film (e.g., with or without a binder such as a fibrillating binder).

In FIG. 2C, the substrate 70 is optionally removed after pressing (e.g., when the substrate 70 does not correspond to the separator or solid electrolyte layer). In other words, the substrate 70 can be made using any suitable material that can be removed after pressing or rolling of the lithium metal layer onto the anode current collector 46.

In FIG. 2D, the substrate 70 further includes a layer 90 arranged between the lithium metal layer 72 and the substrate 70. In some examples, the layer 90 comprises a conductive layer formed on the substrate 70 (e.g., prior to the lithium metal layer 72). In other words, the conductive layer is formed on the substrate 70 prior to electroplating or powder coating of the lithium metal layer 72 on the substrate 70.

For example, the substrate 70 is etched using a chromic acid-based solution. An etched surface of the substrate 70 is coated using a solution including palladium and tin salts. The layer 90 comprises a metal layer (e.g., nickel or copper) that is applied onto the substrate 70 using an electroless plating solution. In other examples, the layer 90 includes conductive paint that is applied to the substrate 70.

In some examples, the layer 90 includes a protective layer arranged between the substrate 70 and the anode active material layer 42 (e.g., the lithium metal). The protective layer prevents the lithium metal layer 72 from entering pores of the substrate 70 (e.g., when the substrate 70 corresponds to the separator). In some examples, the protective layer includes a ceramic layer. In some examples, the ceramic layer is selected from a group consisting of alumina, zirconia, zeolites, lithiated zeolites, or other suitable ceramic materials.

Referring now to FIG. 3, the substrate 70 is masked at one or more mask locations 80 to prevent deposition of the lithium metal layer 72 in the mask locations 80. In some examples, the mask is removed after the lithium metal layer 72 is added. In some examples, the mask includes a mask substrate and an adhesive layer that are attached to the substrate 70 and then removed after plating. In some examples, the mask reduces or prevents deposition of the lithium metal layer 72 on the mask locations 80.

Referring now to FIG. 4, a method 210 for manufacturing an anode electrode is shown. At 210, the substrate is optionally masked and/or the layer is added (e.g., the conductive layer or the protective layer). At 214, a lithium metal layer is formed on the substrate (or the conductive layer or the protective layer if used). The lithium metal layer 72 and the substrate 70 are arranged on one or both sides of anode current collector 46 (with the lithium metal layer 72 facing the anode current collector 46) at 218. At 222, the lithium metal layer(s) 72 are pressed into the anode current collector 46. At 226, the substrate 70 is optionally removed (if the substrate 70 is not the separator). At 230, the anode electrode is arranged in a battery cell.

The anode electrode according to the present disclosure combines lithium deposition on a substrate and the use of 3 dimensional (3D) current collectors. The method avoids the need to directly deposit the lithium metal layer 72 on the anode current collector 46, which can be challenging. In some examples, the substrate 70 corresponds to a separator that is capable of supporting a lithium metal layer while transferring the lithium layer onto the 3D current collector. As can be appreciated, the method for manufacturing the anode current collector with the lithium layer is not limited by width. Surface and/or internal defects of the lithium metal layer are less of a concern since the anode current collector is leveled when pressed into the pores of the 3D anode current collector. The substrate may also serve a dual purpose of enabling the lithium metal layer to be pressed onto the anode current collector and then serving as the separator between the anode and cathode electrodes in the battery cell. The pressing can be used to control the thickness of the lithium metal layer.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A method for manufacturing an anode electrode, comprising:
providing a first substrate, a second substrate, and an anode current collector;
forming a first lithium metal layer on the first substrate and a second lithium metal layer on the second substrate; and
pressing the first lithium metal layer and the second lithium metal layer into the anode current collector to form an anode electrode.

2. The method of claim 1, further comprising removing the first substrate and the second substrate after the pressing.

3. The method of claim 1, wherein the first substrate comprises a separator layer.

4. The method of claim 1, wherein the first substrate comprises a polymer film.

5. The method of claim 1, wherein forming the first lithium metal layer on the first substrate includes at least one of electroplating, vapor deposition, powder coating, and spraying the first lithium metal layer on the first substrate.

6. The method of claim 1, wherein the first substrate comprises a solid electrolyte layer.

7. The method of claim 6, wherein the solid electrolyte layer is selected from a group consisting of a polymer electrolyte, an oxide-based electrolyte, and a sulfide-based electrolyte.

8. The method of claim 6, wherein the solid electrolyte layer is selected from a group consisting of a solvent-free polymer electrolyte layer, a gel polymer electrolyte layer, a composite polymer electrolyte layer, a polyethylene oxide (PEO) layer, a polyacrylonitrile (PAN) layer, a polycarbonate layer, and a polysiloxane layer.

9. The method of claim 1, further comprising arranging a protective layer on the first substrate between the first lithium metal layer and the first substrate.

10. The method of claim 9, wherein the protective layer comprises ceramic.

11. The method of claim 9, wherein the protective layer is selected from a group consisting of alumina, zirconia, zeolites, lithiated zeolites, and combinations thereof.

12. The method of claim 1, further comprising adding a conductive layer to at least one surface of the first substrate prior to forming the first lithium metal layer on the first substrate.

13. The method of claim 1, wherein the anode current collector comprises one of a mesh current collector, an expanded metal current collector, and a perforated current collector.

14. The method of claim 1, wherein the anode current collector is made of a material selected from a group consisting of copper, stainless steel, brass, bronze, zinc, aluminum, and alloys thereof.

15. A method for manufacturing an anode electrode, comprising:
providing a first substrate, a second substrate, and an anode current collector including voids,
wherein the anode current collector comprises one of a mesh current collector, an expanded metal current collector, and a perforated current collector, and
wherein the anode current collector is made of a material selected from a group consisting of copper, stainless steel, brass, bronze, zinc, aluminum, and/or alloys thereof;
forming a first lithium metal layer on the first substrate and a second lithium metal layer on the second substrate,
wherein forming the first lithium metal layer on the first substrate includes at least one of electroplating, vapor deposition, powder coating, and spraying the first lithium metal layer on the first substrate; and
pressing the first lithium metal layer and the second lithium metal layer into the voids of the anode current collector to form an anode electrode.

16. The method of claim 15, further comprising removing the first substrate and the second substrate after the pressing.

17. The method of claim 15, wherein the first substrate comprises a solid electrolyte layer.

18. The method of claim 15, wherein the first substrate comprises a polymer layer.

19. The method of claim 15, further comprising arranging a protective layer on the first substrate between the first lithium metal layer and the first substrate, wherein the protective layer comprises ceramic.

20. The method of claim 15, further comprising forming a conductive layer on the first substrate prior to forming the first lithium metal layer on the first substrate.
